(19) United States
(12) Patent Application Publication
(10) Pub. No.: US 2017/0193771 A1
(43) Pub. Date: Jul. 6, 2017

(54) SECURITY DEVICE

(71) Applicant: Checkpoint Systems, Inc., Thorofare, NJ (US)

(72) Inventors: Adam Mark Will, Fort Mill, SC (US); Scott A. Sattizahn, Charlotte, NC (US)

(21) Appl. No.: 14/984,470

(22) Filed: Dec. 30, 2015

(51) Int. Cl. G08B 13/14

(52) U.S. Cl. CPC G08B 13/1463

(57) ABSTRACT

A security device is provided that includes a leash configured to be operably coupled to a product. The security device may also include a first tag. The first tag may include an attachment sensor configured to sense an operable coupling of the first tag to a surface. The first tag may also include a ratchet assembly supported within a housing of the first tag such that the ratchet assembly is rotatable in a tightening direction to tighten the leash and a loosening direction to loosen the leash. The tag may also include a locking assembly moveable between a locked position and an unlocked position, where in the locked position the locking assembly is configured to prevent the ratchet assembly from being rotated in the loosening direction. The tag may also include an alarm assembly configured to alarm in response to the attachment sensor not sensing the operable coupling of the first tag to the surface, the alarm assembly being configured to disarm responsive to interaction with a key, where access to the alarm assembly for the key is prevented when the first tag is operably coupled to the product.

### TECHNICAL FIELD

Various example embodiments relate generally to retail theft deterrent and merchandise protection devices and methods.

### BACKGROUND

Customers often wish to visually inspect merchandise, in particular expensive merchandise, before deciding to purchase it. Therefore, retail stores may have a difficult time securing this displayed merchandise. Typical security devices primarily used to prevent or deter theft in retail environments may be configured to be attached to a product or packaging of a product. In some cases, these security devices may include acousto-magnetic or radio frequency tags which can be detected by security gates and trigger an alarm. However, in some instances, these tags may be removed with little to no damage to the product or the product may be removed from the packaging to which the tag is attached, thereby defeating the ability of the tags to detect a theft event. Even further, when merchandise has separable components (e.g., a drill having separable battery), retail stores may have difficulty in securing the separable components. For example, while a tag may secure the drill, it may difficult to simultaneously secure both the battery and the drill while being able to retain the functionality of the drill.

### BRIEF SUMMARY OF SOME EXAMPLES

Accordingly, some example embodiments provide a security device for effectively displaying securing merchandise, such as merchandise having separable components. In one example embodiment, a security device is provided that includes a leash configured to be operably coupled to a product. The security device may also include a first tag. The first tag may include an attachment sensor configured to sense an operable coupling of the first tag to a surface. The first tag may also include a ratchet assembly supported within a housing of the first tag such that the ratchet assembly is rotatable in a tightening direction to tighten the leash and a loosening direction to loosen the leash. The tag may also include a locking assembly moveable between a locked position and an unlocked position, where in the locked position the locking assembly is configured to prevent the ratchet assembly from being rotated in the loosening direction. The tag may also include an alarm assembly configured to alarm in response to the attachment sensor not sensing the operable coupling of the first tag to the surface, the alarm assembly being configured to disarm responsive to interaction with a key, where access to the alarm assembly for the key is prevented when the first tag is operably coupled to the product.

In another example embodiment, a security device is provided that includes a leash configured to be operably coupled to a product. The security device may also include a first tag. The first tag may include an attachment sensor configured to sense an operable coupling of the first tag to a surface. The first tag may also include a ratchet assembly supported within a housing of the first tag such that the ratchet assembly is rotatable in a tightening direction to tighten the leash and a loosening direction to loosen the leash. The tag may also include a locking assembly moveable between a locked position and an unlocked position, where in the locked position the locking assembly is configured to prevent the ratchet assembly from being rotated in the loosening direction, and where the locking assembly cannot be moved from the locked position to the unlocked position when the first tag is operably coupled to the product.

### BRIEF DESCRIPTION OF THE SEVERAL VIEWS OF THE DRAWING(S)

Reference will now be made to the accompanying drawings, which are not necessarily drawn to scale, and wherein:

FIG. 1 illustrates a block diagram of a security device disposed on a product according to an example embodiment;

FIG. 2 illustrates a sectional view of a first tag according to an example embodiment;

FIG. 3 illustrates a block diagram of a first surface of a first tag according to an example embodiment;

FIG. 4 illustrates a block diagram of a second surface of a first tag according to an example embodiment; and

FIG. 5 illustrates a block diagram of a security device according to a further example embodiment.

### DETAILED DESCRIPTION

Some example embodiments now will be described more fully hereinafter with reference to the accompanying drawings, in which some, but not all embodiments are shown. Indeed, the examples described and pictured herein should not be construed as being limiting as to the scope, applicability, or configuration of the present disclosure. Like reference numerals refer to like elements throughout. Furthermore, as used herein, the term “or” is to be interpreted as a logical operator that results in true whenever one or more of its operands are true. As used herein, “operable coupling” should be understood to relate to direct or indirect connection that, in either case, enables at least a functional interconnection of components that are operably coupled to each other.

Security devices may be affixed to products in a commercial space (e.g., a retail store) in order to secure the products on which the tags are affixed or to effectively manage or monitor inventory within the retail space. If products are outfitted with security devices, the security devices may be used to ensure that the products are not removed from the retail space without proper point of sale processing. In some cases, a product may be put on display for a customer to view, “try out”, or “experience” before purchasing. In order to protect the displayed product, a security device may be operably coupled to the product. Therefore, if an individual tried to steal the displayed product without removing the security device first, the security device may cause alarming functions when exposed to predetermined electromagnetic field (e.g., pedestals located at the retail store exit). Even if the individual tried to remove the security device in attempt to steal the displayed product, the tag may be configured to alarm upon removal from the product to which the tag was attached. Traditionally, the security device may be unlocked and removed from the product by a key without causing an alarming function. Therefore, in order to avoid detection, sophisticated thieves might employ stolen or counterfeit magnetic keys to remove and unlock the tag. Therefore, in order to increase security of displayed products, retailers may utilize a security device that is configured to always alarm when removed from the product to which the security device was attached and that cannot be disarmed or unlocked while attached to the product. Even further, to ensure that a product having separate components is effectively secured (e.g., a tool have a separable battery), retailers may utilize a security device that is configured to simultaneously secure both a first portion and a second portion of the product. In the example embodiments described herein, the terms first product and second product may be parts or portions of a single product having separable components. However, in other examples, the first and second product could be different products or objects. In one example, the first product may be a retail object and the second product could be a shelf or other object tethered to the retail object. Moreover, it should be appreciated that in some example embodiments the security device may include a tag that can be attached to a surface of a first product (or object) that can be tethered to a second product (or object). In this context, the surface may be a surface of a retail object, a shelf, or any other object in the retail store.

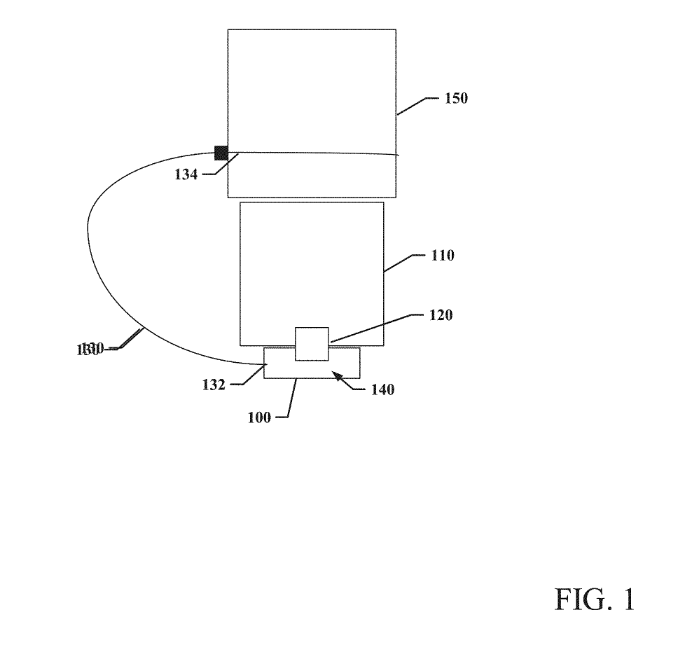

FIG. 1 illustrates a security device disposed on a product according to an example embodiment. The security device may include at least a first tag 100 and a leash 130. The first tag 100 may be formed entirely, or in part, of a solid material. As such, all or portions of the first tag 100 may be formed from molded plastic or other rigid materials. Even further, the first tag 100 may be operably coupled to a first product 110. The first tag 100 may be operably coupled to a first product 110 by a coupling, such as an adhesive, hooks, tab locks, lockable posts, or the like. In some cases, the first tag 100 may have a tag housing 140. An attachment sensor 120 may be operably coupled to the tag housing 140. The attachment sensor 120 (e.g., a plunger, etc.) may be configured to sense that the first tag 100 is sufficiently coupled to the first product 110 such that the various theft deterrent functions described herein may be carried out.

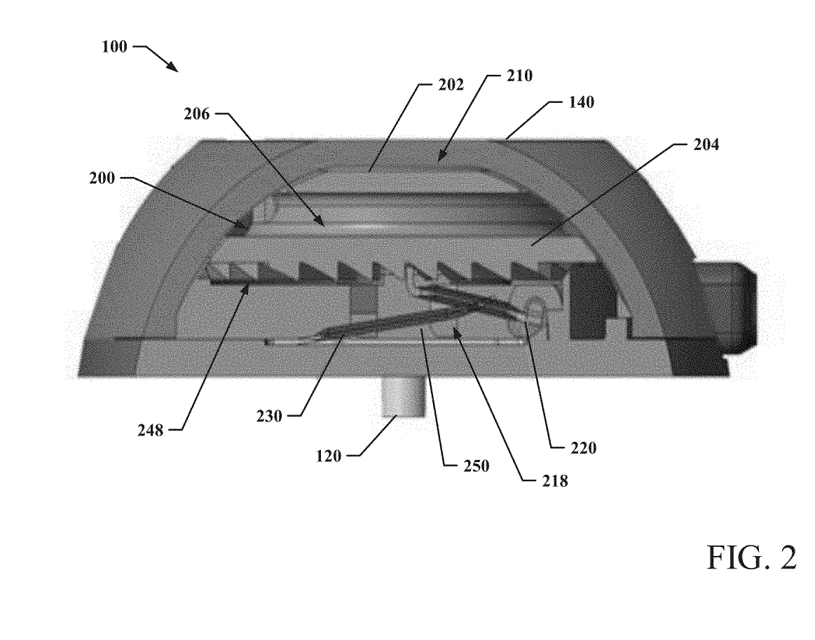

The tag housing 140 may also include a recess adapted to receive the leash 130. The leash may include a plug end 132 and a snare end 134. Specifically, the plug end 132 of the leash 130 may be inserted through the recess in the tag housing 140 for engagement with a ratchet assembly 200 (as described in relation to FIG. 2 below). In some cases, the snare end 134 may be operably coupled to a portion of a second product 150 in order to secure the second product 150 to the first product 110. In some example embodiment, the first tag 100 may include processing circuitry configured to provide a sense loop through the leash 130, where if the leash 130 is tampered with or cut the first tag 100 may alarm. In further example embodiments, the first tag 100 may be operably coupled to the first product 110, and the leash 130 may not be used or employed. Even if the leash 130 is not used or is not coupled to the second product 150, the first tag 100 and its security functions as described herein may used as the functions relate to the first product 110.

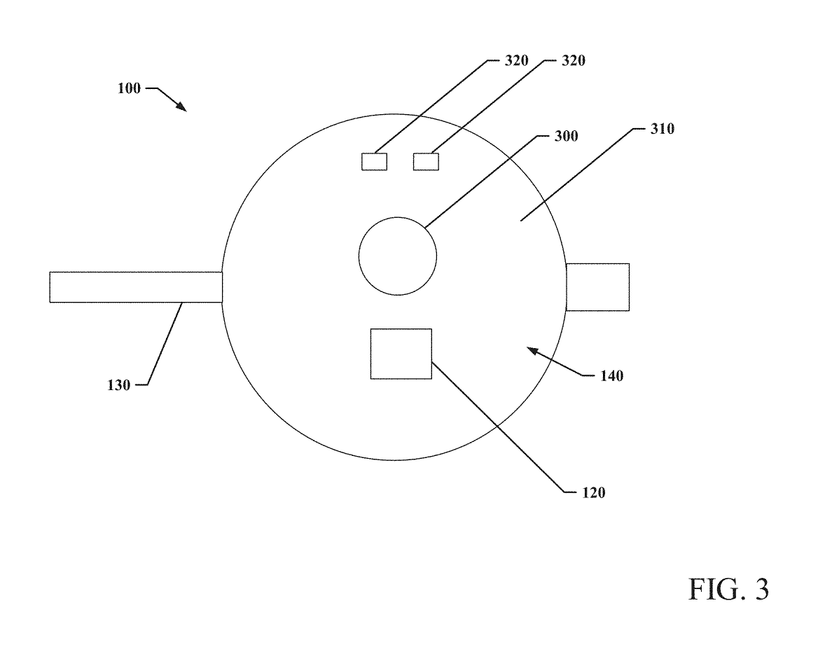

FIG. 2 illustrates a sectional view of the first tag 100 according to an example embodiment. As shown in FIG. 2, a ratchet assembly 200 may be contained within the tag housing 140. The ratchet assembly 200 may include a spool 210 having a first annular flange 202 and a second annular flange 204, which form a storage area 206 therebetween for storing the leash 130. In some cases, a shaft 250 may extend through a circular hole formed in the spool 210 and be operably coupled to the spool 210 such that the spool is rotatable on the shaft 250. The shaft 250 may extend through an opening 300 in a first surface 310 of the tag housing 140 (as described in relation to FIG. 3 below). The opening 300 may be shaped to accommodate the size and shape of the shaft 250. An annular ring of one way gear teeth 248 may be mounted on a first exterior surface of the second annular flange 204 and form part of the ratchet assembly 200 for controlling the rotational movement of the spool 210 within the tag housing 140.

As shown in FIG. 2, a locking assembly 218 may also be disposed in the tag housing 140. The locking assembly 218 may be configured to move between a locked position and an unlocked position. In some cases, the locking assembly 218 may include a pawl 220 and biasing mechanism 230 (e.g., a spring or the like). When the locking assembly is in the locked position, the biasing mechanism 230 may be operably coupled between the pawl 220 and a surface of the tag housing 140. In particular, the pawl 220 may engage the one-way gear teeth 248 of the second annular flange 204. The tension of the biasing assembly 230 biases the pawl 220 against the one-way gear teeth 248 thereby enabling rotation of the spool 202 in a first direction (i.e., a tightening direction) for retracting or tightening the leash while preventing rotation of the spool 202 in a second direction (i.e., loosening direction). In further example embodiments, different configurations of the ratchet assembly 200 and the locking assembly 218 may be used for enabling tightening of the leash 130 in a first direction while preventing loosening of the leash 130 in a second direction.

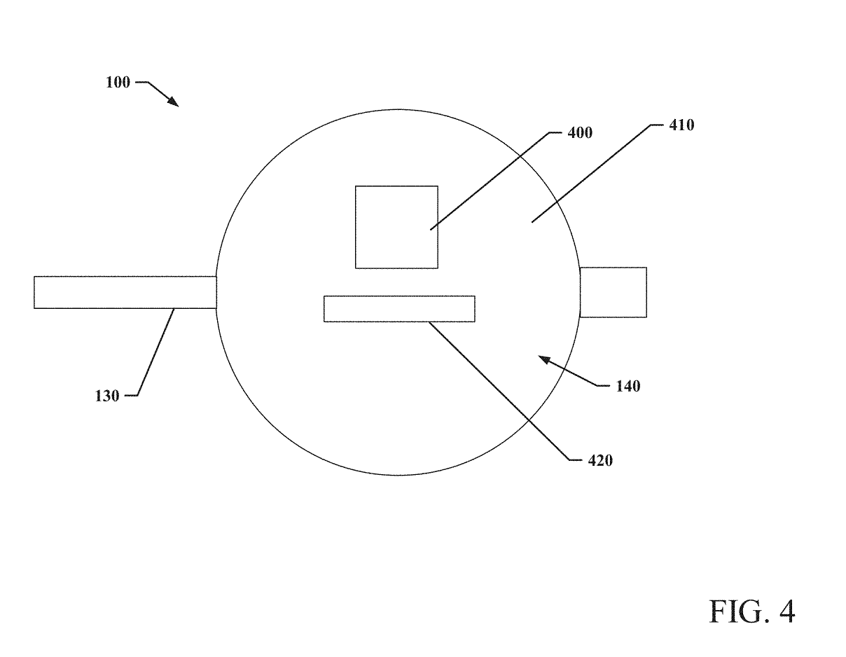

In some embodiments, an alarm assembly may be disposed within the tag housing 140. The alarm assembly may include an audio device (e.g., a piezoelectric, mechanical, or electromechanical beeper, buzzer or other audio signaling device such as an audible alarm). The alarm assembly may also include a speaker portion 400 or other sound generating device that may be provided in the second surface 410 of the tag housing 140 (see FIG. 4).

FIG. 3 illustrates a block diagram of a first surface 310 of the first tag 100 according to an example embodiment. As shown in FIG. 3, the first surface 310 of the tag housing 140 may include the opening 300, the attachment sensor 120, and key apertures 320. The opening 300, as described above, is shaped to accommodate the size and shape of the shaft 250. The first surface 310 may also include the attachment sensor 120. The attachment sensor 120 (e.g., a plunger, etc.) may sense and monitor that the first tag 100 is sufficiently operably coupled to the first product 110. Therefore, if the attachment sensor 140 is depressed against the first product 110, the processing circuitry of the first tag 100 may be configured to detect that the first tag 100 is sufficiently operably coupled to the first product 110. When the processing circuitry detects that the first tag 100 is sufficiently operably coupled to the first product 110, the processing circuitry may not direct the alarm assembly to alarm or alert. However, if the attachment sensor 140 is released, the processing circuitry of the first tag 100 may be configured to detect that the first tag 100 is not sufficiently operably coupled to the first product 110. When the processing circuitry detects that the attachment sensor 140 is not depressed against the first product 110 (i.e., the first tag 100 is not operably coupled to the first product 110), the processing circuitry may direct the alarm assembly to alarm or alert.

Additionally, the first surface 310 may include key apertures 320. The key apertures 320 may align with key projections of a key (e.g., a magnetic key) when placed thereon. When the key is placed within the key apertures 320, the locking assembly 218 may unlock or move to the unlocked position thereby releasing engagement with the ratchet assembly 200. In particular, the tension of the biasing mechanism 230 may be overcome or released causing the pawl 220 to draw down toward the first surface 310 of the tag 100 to disengage and release contact with the one-way gear teeth 248 of the second annular flange 204. When the pawl 220 is unbiased from the second annular flange 204 (and therefore the spool 202), the spool 202 is enabled to rotate freely in either the tightening or loosening direction. By enabling the spool 202 to rotate in the loosening direction, the leash 130 may unwind and the plug end 132 of the leash 130 may be removed via the recess from the tag housing 140. In some cases, when the locking assembly 218 moves to the unlocked position (i.e., in response to the key projections aligning with the key apertures 320), the processing circuitry of the first tag 100 may be configured to direct the alarm assembly to disarm or stop alarming or alerting. Generally speaking, however, the locking assembly 218 may stay in the locked position unless a key is placed in contact or engagement with the key apertures 320. In some cases, the key may be configured to unlock the first tag 100 (i.e., move the locking assembly 218 to the unlocked position) when the key is brought in close proximity to the first surface 310 of the first tag 100. Therefore, in further example embodiments, the first surface 310 of the first tag 100 may not include key apertures 320.

As both the attachment sensor 120 and the key apertures 320 are disposed on the first surface 310 of the tag housing 140, the first tag 100 must be removed from the first product 110 before the key apertures 320 are accessible by the key. As stated above, in order to loosen the leash 130 from the spool 202 (i.e., untighten the snare end 134 of the leash from the second product 150), the key must unlock the first tag 100 (i.e., move the locking assembly 218 to the unlocked position). Therefore, the first tag 100 must be removed from the first product 110 thereby causing the attachment sensor 120 to release from contact with the first product 110. As the alarm assembly may sound when the first tag 100 is removed from the product 100 (i.e., the attachment sensor 120 is released), the first tag 100 may alarm each time the key apertures 320 are accessed.

FIG. 4 illustrates a block diagram of a second surface 410 of the first tag 100 according to an example embodiment. As shown in FIG. 4, the second surface 410 of the first tag 100 may include a speaker portion 400 of the alarm assembly and a tightening mechanism. In the example embodiment illustrated in FIG. 4, the tightening mechanism is a slot 420 in which a coin may be inserted. The slot 420 may operably coupled to the shaft 250 to enable manual rotation of the shaft 250. A coin may correspond to the size and shape of the slot 420. In particular, when the first tag 100 is locked (i.e., the unlocking assembly 218 is in the locked position), the coin may be inserted into the slot 420 to cause rotation of the shaft 250 and thereby the ratchet assembly 200 in a first or tightening direction. In other example embodiments, the shaft 250 may be operably coupled to a flip-up handle located on the second surface 410 of the tag housing 140. The flip-up handle may also be used to manually rotate the shaft 250 and thereby the ratchet assembly 200 in a first or tightening direction when the tag 100 is in the locked position. The second surface 410 of the first tag 100 may also include a speaker portion 400 of the alarm assembly, as described above.

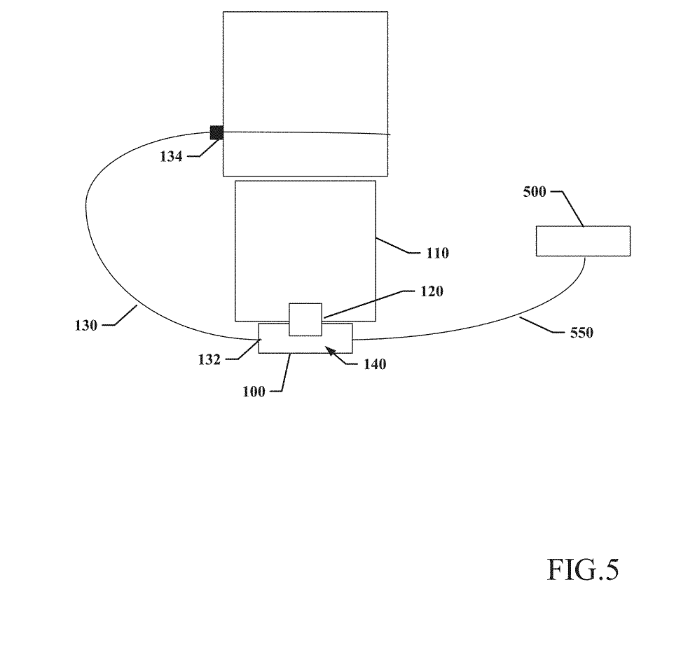

FIG. 5 illustrates a block diagram of a security device according to an example embodiment. As shown in FIG. 5, the first tag 100 may be operably coupled to a first end of a cable 550. The second end of the cable 150 may be operably coupled to a second tag 500. The cable 550 may be a coiled cable that is terminated by strain relief at both the first tag 100 and the second tag 500. In some cases, the first tag 100 and the second tag 500 may be considered one security device. The second tag 500 may also include an alarm assembly and attachment sensor as described above. The second tag 500 may have processing circuitry configured to provide a sense loop through cable 550. Therefore, if the cable 550 is tampered with or cut, the processing circuitry of the second tag 500 may be configured to enable the alarm assembly to alert. In some cases, the second tag 500 may be operably coupled to a surface proximate the first product 110. Therefore, even if the first tag 100 is not removed from the first product in an attempt to steal the first product 100, if the first product 100 is moved in such a way to cause the second tag 500 to be removed from the surface, the alarm assembly of the second tag 500 may alarm. Even further, if the cable 550 is cut in attempt to remove or steal the first product 110 without removing the first tag 100, the second tag 500 may be configured to alarm.

Example embodiments therefore represent a security device that includes a leash configured to be operably coupled to a product. The security device may also include a first tag. The first tag may include an attachment sensor configured to sense an operable coupling of the first tag to a surface. The first tag may also include a ratchet assembly supported within a housing of the first tag such that the ratchet assembly is rotatable in a tightening direction to tighten the leash and a loosening direction to loosen the leash. The tag may also include a locking assembly moveable between a locked position and an unlocked position, where in the locked position the locking assembly is configured to prevent the ratchet assembly from being rotated in the loosening direction. The tag may also include an alarm assembly configured to alarm in response to the attachment sensor not sensing the operable coupling of the first tag to the surface, the alarm assembly being configured to disarm responsive to interaction with a key, where access to the alarm assembly for the key is prevented when the first tag is operably coupled to the product.

In some embodiments, the features described above may be augmented or modified, or additional features may be added. These augmentations, modifications and additions may be optional and may be provided in any combination. Thus, although some example modifications, augmentations and additions are listed below, it should be appreciated that any of the modifications, augmentations and additions could be implemented individually or in combination with one or more, or even all of the other modifications, augmentations and additions that are listed. As such, for example, the locking assembly may not be moved from the locked position to the unlocked position when the first tag is operably coupled to the product. Alternatively or additionally, the locking assembly may require the key to move from the locked position to the unlocked position. In an example embodiment, the leash may be removable from the ratchet assembly, and the leash may include a snare end and a plug end, where the snare end may be configured to be operably coupled around a portion of a different object, and where the plug end may be configured to be inserted through a recess in a housing of the first tag to operably couple the leash to the ratchet assembly. Alternatively or additionally, the tightening mechanism may include a slot to enable rotation of the ratchet assembly. Alternatively or additionally, the leash may be wound around the ratchet assembly in response to rotation of the ratchet assembly in the tightening direction thereby tightening the snare end. Alternatively or additionally, the plug end may be prevented from being removed from the recess in the housing when the locking assembly is in the locked position. In some cases, the locking assembly may include a spring and a pawl, and when the locking assembly is in the locked position, the spring may bias the pawl into engagement with the ratchet assembly. In some cases, the key may be required to overcome the bias of the spring to enable the pawl to be released from the ratchet assembly to move the locking assembly to the unlocked position. In some cases, the key may draw the pawl away from ratcheting teeth of the ratchet assembly to release the pawl from the ratchet assembly. In some example embodiments, the security device may further include a second tag operably coupled to the housing via a cable. In some cases, the second tag may include processing circuitry that is configured to provide a sense loop through the cable. In some cases, the second tag may further include a second alarm assembly. In some example embodiments, the housing may further include key apertures configured for engagement with the key, and the key may be a magnetic key. In one example embodiment, the tightening mechanism may include a slot to enable rotation of the ratchet assembly

Many modifications and other embodiments set forth herein will come to mind to one skilled in the art to which these embodiments pertain having the benefit of the teachings presented in the foregoing descriptions and the associated drawings. Therefore, it is to be understood that the embodiments covered are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements or functions, it should be appreciated that different combinations of elements or functions may be provided by alternative embodiments without departing from the scope of the appended claims. In this regard, for example, different combinations of elements or functions than those explicitly described above are also contemplated as may be set forth in some of the appended claims. In cases where advantages, benefits or solutions to problems are described herein, it should be appreciated that such advantages, benefits or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A security device comprising:
a leash configured to be operably coupled to a product; and
a first tag comprising:
an attachment sensor configured to sense an operable coupling of the first tag to a surface;
a ratchet assembly supported within a housing of the first tag such that the ratchet assembly is rotatable in a tightening direction to tighten the leash and a loosening direction to loosen the leash;
a locking assembly moveable between a locked position and an unlocked position, wherein in the locked position the locking assembly is configured to prevent the ratchet assembly from being rotated in the loosening direction; and
an alarm assembly configured to alarm in response to the attachment sensor not sensing the operable coupling of the first tag to the surface, the alarm assembly being configured to disarm responsive to interaction with a key, wherein access to the alarm assembly for the key is prevented when the first tag is operably coupled to the product.

2. The security device of claim 1, wherein the locking assembly cannot be moved from the locked position to the unlocked position when the first tag is operably coupled to the product.

3. The security device of claim 2, wherein the locking assembly requires the key to move from the locked position to the unlocked position.

4. The security device of claim 1, wherein the leash is removable from the ratchet assembly, and wherein the leash comprises a snare end and a plug end, wherein the snare end is configured to be operably coupled around a portion of a different object, and wherein the plug end is configured to be inserted through a recess in a housing of the first tag to operably couple the leash to the ratchet assembly.

5. The security device of claim 4, wherein the leash is wound around the ratchet assembly in response to rotation of the ratchet assembly in the tightening direction thereby tightening the snare end.

6. The security device of claim 4, wherein the plug end is prevented from being removed from the recess in the housing when the locking assembly is in the locked position.

7. The security device of claim 1, wherein the locking assembly comprises a spring and a pawl, and wherein when the locking assembly is in the locked position, the spring biases the pawl into engagement with the ratchet assembly.

8. The security device of claim 7, wherein the key is required to overcome the bias of the spring to enable the pawl to be released from the ratchet assembly to move the locking assembly to the unlocked position.

9. The security device of claim 8, wherein the key draws the pawl away from ratcheting teeth of the ratchet assembly to release the pawl from the ratchet assembly.

10. The security device of claim 1, wherein the security device further comprises a second tag operably coupled to the housing via a cable.

11. The security device of claim 10, wherein the second tag comprises processing circuitry configured to provide a sense loop through the cable.

12. The security device of claim 10, wherein the second tag further comprises a second alarm assembly.

13. The security device of claim 1, wherein the housing further comprises key apertures configured for engagement with the key, and wherein the key is a magnetic key.

14. The security device of claim 1, wherein the tightening mechanism comprises a slot to enable rotation of the ratchet assembly.

15. A security device comprising:
a leash configured to be operably coupled to a product; and
a first tag comprising:
an attachment sensor configured to sense an operable coupling of the first tag to a surface;
a ratchet assembly supported within a housing of the first tag such that the ratchet assembly is rotatable in a tightening direction to tighten the leash and a loosening direction to loosen the leash; and
a locking assembly moveable between a locked position and an unlocked position, wherein in the locked position the locking assembly is configured to prevent the ratchet assembly from being rotated in the loosening direction, and wherein the locking assembly cannot be moved from the locked position to the unlocked position when the first tag is operably coupled to the product.

16. The security device of claim 1, wherein the first tag further comprises an alarm assembly configured to alarm in response to the attachment sensor not sensing the operable coupling of the first tag to the surface, the alarm assembly being configured to disarm responsive to interaction with a key, wherein access to the alarm assembly for the key is prevented when the first tag is operably coupled to the product.

17. The security device of claim 1, wherein the locking assembly requires the key to move from the locked position to the unlocked position.

18. The security device of claim 1, wherein the leash is removable from the ratchet assembly, and wherein the leash comprises a snare end and a plug end, wherein the snare end is configured to be operably coupled around a portion of a different object, and wherein the plug end is configured to be inserted through a recess in a housing of the first tag to operably couple the leash to the ratchet assembly.

19. The security device of claim 18, wherein the leash is wound around the ratchet assembly in response to rotation of the ratchet assembly in the tightening direction thereby tightening the snare end.

20. The security device of claim 18, wherein the plug end is prevented from being removed from the recess in the housing when the locking assembly is in the locked position.
